(19) United States
(12) Patent Application Publication
(10) Pub. No.: US 2004/0249691 A1
(43) Pub. Date: Dec. 9, 2004

(54) Method, system and computer product for strategic priority order tracking

(76) Inventors: H. Mike Schell, Brandon, MS (US); Dustin Majure, Philadelphia, MS (US)

Correspondence Address: CANTOR COLBURN LLP, 55 GRIFFIN ROAD SOUTH, BLOOMFIELD, CT, 06002, US

(21) Appl. No.: 10/456,657

(22) Filed: Jun. 5, 2003

(51) Int. Cl. G06F 17/60

(52) U.S. Cl. 705/8

(57) ABSTRACT

A method for strategic priority order tracking comprising receiving a request from a user system to access an order tracking database. The data contained in the order tracking database is sourced from at least one legacy database. Order status data for a customer order is transmitted to the user system in response to a request from the user system to display the order status data for the customer order. The order status data is responsive to data included in the order tracking database corresponding to the customer order and the order status data is displayable as a single screen on the user workstation. A customized report is created in response to a request from the user system to create the customized report. The customized report is responsive to data included in the order tracking database, a data field, a filter option and a sorting option. The customized report is transmitted to the user system in response to the creating a customized report. The order status data for the customer order is updated in response to a request from the user system. The updating includes updating data in the at least one legacy database. The order status data is transmitted to a provisioning group responsible for performing labor requested on the customer order in response to updating the order status data. A priority level associated with the customer order is escalated in response to a request to escalate the customer order.

### BACKGROUND OF THE INVENTION

The present disclosure relates generally to strategic priority order tracking and in particular, to a method of tracking designed orders through the provisioning process including a tool for performing cause analysis.

Telecommunication service providers, such as the Regional Bell Operating Companies (RBOCs), frequently have large customer service orders with other telecommunications companies. Such large service orders generally involve the design of telecommunication circuits and then the testing of the circuits. It is important to both the service provider and the customer that these orders get completed on time.

As a result, the RBOCs may utilize Network Provisioning Resolution Centers (NPRC) to monitor the progress of these large service customer orders. The NPRC monitors the progress of the orders and alerts various concerned parties about the status of the orders. The NPRC gathers information from databases in the legacy computer systems in order to retrieve the information necessary to monitor the orders.

For the RBOCs, the legacy systems may include a collection of databases established by the Bell System and currently managed by Telcordia. The databases accessed by the NPRC may include: Trunk Integrated Record Keeping System (TIRKS), Service Order Analysis and Control (SOAC), Service Order Communications System (SOCS), Work and Force Administration/Control (WFA/C), Work and Force Administration/Dispatch In (WFA/DI), Work and Force Administration/Dispatch Out (WFA/DO), Digital Provisioning (DPRO), and Loop Facility Assignment Control System (LFACS). These databases are on different computer platforms and utilize different operating systems and database software. Each database contains certain information used by the NPRC to assist in tracking orders.

TIRKS supports the total circuit provisioning process. The data and documents contained in TIRKS may include: circuit order control, circuit design, inventory record maintenance, selection and assignment of components of inventory work order generation to satisfy requests for communication services, and construction planning and forecasting.

SOAC receives service orders from the service order processor (SOP), parses the Field Identifiers (FIDs) and Universal Service Order Codes (USOCs), generates loop facility and central office assignment requests, and sends assigned orders back to the SOP and to other provisioning systems.

The primary function of SOCS is the real-time routing of formatted service orders via the Queued Message Service/BellSouth Open System Information Platform (QMS/BOSIP) to physical printers, personal computers, and mini-computers to support the provisioning and completion of service orders. SOCS performs the collection, storage, and distribution of service orders to all user departments, including the service order driven mechanized systems. The SOCS system may route service orders to over one hundred separate entities and may feed over twenty-five other mechanized systems that are needed to provide service to the customer and bill the customer. SOCS also for produces administrative reports.

The WFA systems are Telcordia application products that help coordinate personnel assignments and manage/automate the tasks required to install and repair facilities, trunks, special service circuits, and residential lines. WFA/C coordinates and tracks installation and maintenance activity of the entire circuit, from design to completion, and provides ready access to detailed circuit records and circuit history data. WFA/DI automates the work assignments of central office technicians to install and maintain “designed” as well as certain “non-designed” services. WFA/DO supports the outside field technicians for Special Services (SSIM), and the inside personnel in the Special Service Dispatch Administration Center (SSDAC). The system eliminates the paper flow and manual work involved in administration of the SSIM dispatch and provides pricing as well as loading for these personnel.

DPRO is designed to reduce the provisioning interval for DS1 (DS1 stands for “digital signal one” and represents a digital signal rate of 1.544 megabytes (MBs)) services to external customers by automating the information flow from SOAC/SOCS through DPRO, with data from LFACS and a Loop Electronics Inventory Module (LEIM), to TIRKS. DPRO provides span design information from Outside Plant Engineering (OSPE) to all appropriate downstream organizations.

The current NPRC process for monitoring orders is a highly manual and time-consuming process. Much time is spent performing manual inquiries into the legacy system databases, recording information and making notes, organizing by priorities, marking calendars for follow up, and determining what steps needs to be performed next. The manual tracking of orders carries with it the risks of miscommunication, lack of standardization, and improper prioritization. Currently, order printouts of the top priority orders that need to be monitored are periodically collected and physically delivered to an NPRC representative. At the NPRC, the orders are logged, separated, and filed in folders. A NPRC representative must then access each legacy system separately to individually check the status of each order. Each legacy system has some of the information necessary to check the status of an order. An NPRC representative accesses the legacy systems through a character user interface (CUI) on a personal computer.

As a result, a NPRC representative must have several “green screens” open at once and must navigate through the non-user-friendly legacy systems. This is not a point and click environment. The user must open several screens from different databases to obtain the necessary information. The user cannot maneuver back and forth from screen to screen in this environment with a click of the mouse or the “Back” and “Forward” buttons of a web browser as computer users are so accustomed to today. Additionally, the user must examine multiple screens, up to ninety-five legacy transactions per order, looking for all the necessary information. It cannot be gleaned simply from a single screen. This is time consuming and uses valuable human resources. Once the NPRC has the status for an order, the status of the order is then manually filed in paper form. Based on the written status and manual prioritization, an NPRC representative makes follow-up calls to those people or organizations that must be informed of the status of certain orders. An NPRC representative then marks any necessary follow ups for particular orders on a physical calendar and must continue to monitor the status.

There are numerous problems with this manual process. First, the manual process is very cumbersome and time consuming, and thus the number of orders that can be managed efficiently is limited. This results in orders that are not managed at all or are managed inefficiently, which in turn results in deadlines being missed and dissatisfied customers. Additionally, when intermediate deadlines are missed, the targeted interval is shortened for the portion of the provisioning at the end of the work period, which results in inefficiency of scheduling and increased overtime. All of these problems may result in lost revenue.

### BRIEF DESCRIPTION OF THE INVENTION

One aspect of the present invention is a method for strategic priority order tracking. The method comprises receiving a request from a user system to access an order tracking database. The data contained in the order tracking database is sourced from at least one legacy database. Order status data for a customer order is transmitted to the user system in response to a request from the user system to display the order status data for the customer order. The order status data is responsive to data included in the order tracking database corresponding to the customer order and the order status data is displayable as a single screen on the user workstation. A customized report is created in response to a request from the user system to create the customized report. The customized report is responsive to data included in the order tracking database, a data field, a filter option and a sorting option. The customized report is transmitted to the user system in response to the creating a customized report. The order status data for the customer order is updated in response to a request from the user system. The updating includes updating data in the at least one legacy database. The order status data is transmitted to a provisioning group responsible for performing labor requested on the customer order in response to updating the order status data. A priority level associated with the customer order is escalated in response to a request to escalate the customer order.

In another aspect, a system for strategic priority order tracking comprises a network and a first storage device in communication with the network. The first storage device includes an order tracking database. The system further comprises a second storage device in communication with the network. The second storage device includes at least one legacy database. The system also comprises a user system in communication with the network and a host system in communication with the network. The host system includes application software to implement a strategic priority order tracking method comprising receiving a request from the user system to access the order tracking database. The data contained in the order tracking database is sourced from at least one legacy database. Order status data for a customer order is transmitted to the user system in response to a request from the user system to display the order status data for the customer order. The order status data is responsive to data included in the order tracking database corresponding to the customer order and the order status data is displayable as a single screen on the user workstation. A customized report is created in response to a request from the user system to create the customized report. The customized report is responsive to data included in the order tracking database, a data field, a filter option and a sorting option. The customized report is transmitted to the user system in response to the creating a customized report. The order status data for the customer order is updated in response to a request from the user system. The updating includes updating data in the at least one legacy database. The order status data is transmitted via the network to a provisioning group responsible for performing labor requested on the customer order in response to updating the order status data. A priority level associated with the customer order is escalated in response to a request to escalate the customer order.

In a further aspect, a computer program product for strategic priority order tracking comprises a storage medium readable by a processing circuit and storing instructions for execution by the processing circuit for performing a method. The method comprises receiving a request from a user system to access an order tracking database. The data contained in the order tracking database is sourced from at least one legacy database. Order status data for a customer order is transmitted to the user system in response to a request from the user system to display the order status data for the customer order. The order status data is responsive to data included in the order tracking database corresponding to the customer order and the order status data is displayable as a single screen on the user workstation. A customized report is created in response to a request from the user system to create the customized report. The customized report is responsive to data included in the order tracking database, a data field, a filter option and a sorting option. The customized report is transmitted to the user system in response to the creating a customized report. The order status data for the customer order is updated in response to a request from the user system. The updating includes updating data in the at least one legacy database. The order status data is transmitted to a provisioning group responsible for performing labor requested on the customer order in response to updating the order status data. A priority level associated with the customer order is escalated in response to a request to escalate the customer order.

### BRIEF DESCRIPTION OF THE DRAWINGS

Referring to the exemplary drawings wherein like elements are numbered alike in the several FIGURES:

FIG. 1 is a block diagram of an exemplary system for performing strategic priority order tracking;

FIG. 2 is a block diagram of an alternate exemplary system for performing strategic priority order tracking;

FIG. 3 is an exemplary process flow for performing strategic priority order tracking;

FIGS. 4A and 4B depict an exemplary process flow for the strategic priority tracking system of an exemplary embodiment of the present invention;

FIG. 5 depicts exemplary order escalation logic that may be utilized by an exemplary embodiment of the present invention;

FIGS. 6A and 6B depict order escalation logic that may be utilized by an exemplary embodiment of the present invention;

FIG. 7 is an exemplary user interface screen for listing work orders, with numerous characteristics for each order;

FIG. 8 is an exemplary user interface screen for displaying detailed information for a particular order;

FIG. 9 is an exemplary user interface screen for displaying DRPO data via the SPOT application program;

FIG. 10 is an exemplary user interface screen for displaying SOAC and LFACS error via the SPOT application program;

FIG. 11 is an exemplary user interface screen for displaying a WFA log via the SPOT application program;

FIG. 12 is an exemplary user interface for submitting a note to legacy systems via the SPOT application program;

FIG. 13 is an exemplary user interface for performing user administration functions; and

FIG. 14 is an exemplary user interface for performing system administration functions.

### DETAILED DESCRIPTION OF THE INVENTION

An exemplary embodiment of the present invention interacts with order tracking and provisioning legacy computer systems, providing provisioning centers with the ability to track orders both in their respective systems as well as through the overall “big picture” of the order's lifecycle. This allows users to have quick access to data from several systems in a single place rather then having to review the data in several different systems at the same time. The presentation of the data fields together and the application of business logic to prioritize these orders helps the various provisioning center users better control the provisioning process.

An exemplary embodiment of the present invention is a strategic priority order tracking (SPOT) application program that collects service order information from various legacy systems and provides a sorted and ordered view of the current order status, location in the service provisioning process, and current remarks or issues related to meeting the committed due date (CDD) of an order. In addition, other designed orders are tracked, providing parity to all services. The summary and prioritization of identified service order status as provided by the SPOT application program provides a tool to track, escalate, and identify the need for management action. This may help to ensure that service commitments are met. The SPOT application includes the ability to track Inter-Exchange Carrier (IEC), Bellsouth Business Systems (Non-Access) (BBS), and Competitive Local Exchange Carrier (CLEC) designed (SL2) services for members of the NPRC, Work Management Center (WMC), Circuit Provisioning Group (CPG), Access Customer Advocate Center (ACAC), Service Advocate Center (SAC), and other Bellsouth telecommunications groups. CLEC SL2 orders are those placed by the CLEC under the design tariff. These orders are marked as Unbundled Network Element (UNE) orders in order to create reports to verify parity of service. An exemplary embodiment of the present invention is also capable of tracking SL1, or non-designed, orders.

In addition, an exemplary embodiment of the present invention provides a table driven report engine that allows a user to define and execute a custom report based on elements contained in the SPOT database or by combining existing reports. Other functions included in an exemplary embodiment of the present invention include the ability to create reports based on specific date ranges, the ability to split the SPOT application to execute portions of the application on different host systems in order to improve performance, an instant messaging facility, a facility to pull and view information from a legacy system (e.g., DPRO, SOCS) into the SPOT system without having to log into the legacy system, allowing access to particular data fields based on user profiles, and the ability to add new orders in a bulk mode.

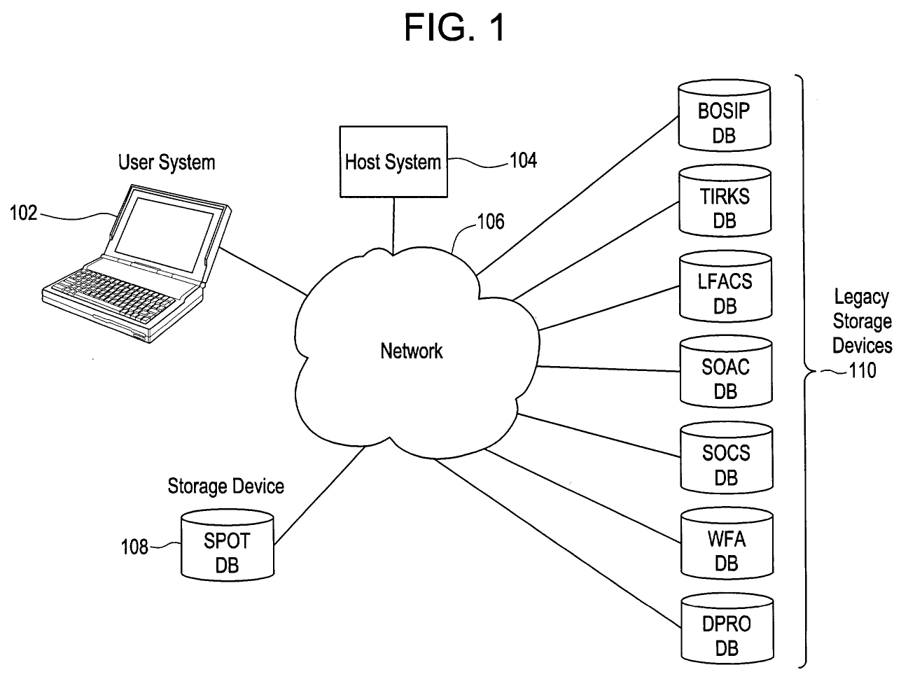

In FIG. 1, is a block diagram of an exemplary system for performing strategic priority order tracking is generally shown. The system includes one or more user systems 102 through which users at one or more geographic locations may contact the host system 104 to initiate the execution of the SPOT application. In an exemplary embodiment, a NPRC user accesses a user system 102 located at a NPRC and a customer accesses a user system 102 located at a user location to access a SPOT application program located on the host system 104 to track orders through the order process. The user systems 102 are coupled to the host system 104 via a network 106. Each user system 102 may be implemented using a general-purpose computer executing a computer program for carrying out the processes described herein. The user system 102 may be any type of user system known in the art including a personal computer, a personal digital assistant and a host-attached terminal. If the user system 102 has the capabilities (e.g., a personal computer), the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system 104 through multiple networks (e.g., intranet and Internet) so that not all user systems 102 are coupled to the host system 104 through the same network. One or more of the user systems 102 and the host system 104 may be connected to the network 106 in a wireless fashion.

The storage devices 108, 110 may be implemented using a variety of devices for storing electronic information. It is understood that the storage devices 108, 110 may be implemented using memory contained in the host system 104 or they may be separate physical devices. The storage devices 108, 110 are each logically addressable as a consolidated data source across a distributed environment that includes a network 106. The physical data may be located in a variety of geographic locations depending on application and access requirements. Information stored in the storage devices 108, 110 may be retrieved and manipulated via the host system 104. The storage device 108 includes the SPOT database and may also include other kinds of data such as information concerning user updates to orders (e.g., a user identifier, date, and time) and user access profiles. The SPOT database may be implemented utilizing any type of database known in the art (e.g., a relational database). The legacy storage devices 110 include legacy system databases. In an exemplary embodiment of the present invention there are seven legacy databases contained on the legacy storage devices 110: BOSIP, TIRKS, LFACS, SOAC, SOCS, WFA (WFA/C, WFA/DI and WFA/DO) and DPRO. These legacy databases are interfaced, via the network 106 with a single SPOT database located on storage device 108. In an exemplary embodiment of the present invention, the information accessible through SPOT is maintained on a separate database (i.e., the SPOT database). Commercial search tools and expert systems associated with the commercial database product being used for the SPOT database 106 may be utilized to search and sort the SPOT database records. In an exemplary embodiment, the host system 104 operates as a database server and coordinates access to application data including data stored on storage device 108, 110.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may also include a firewall to prevent unauthorized access to the host system 104 and enforce any limitations on authorized access. For instance, an administrator may have access to the entire system and have authority to modify portions of the system. A firewall may be implemented using conventional hardware and/or software as is known in the art.

The host system 104 may also operate as an application server. The host system 104 executes one or more computer programs to perform SPOT application functions. These functions include the tracking an order from inception to completion. Processing may be shared by the user system 102 and the host system 104 by providing an application (e.g., java applet) to the user system 102. Alternatively, the user system 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

In an exemplary embodiment of the present invention, the host system 104 is implemented utilizing two central processing units, one to perform the data gathering and one to update data on the legacy system databases. In this manner, each CPU may be optimized to perform a particular type of function. The data gathering CPU is utilized to collect data from the legacy system databases for storage on the SPOT database. The data gathering CPU may be optimized for data transfer and update to the SPOT database. The CPU for updating data on the legacy system databases may be optimized for data update to the legacy databases. In addition, the SPOT application software would be modularized to support different segments of the code running on different CPUs. Splitting the processing up between two or more CPUs may result in increased performance for the overall SPOT system. In an additional alternative embodiment, the SPOT database is split into two physical databases, one for pending orders and the other for completed orders.

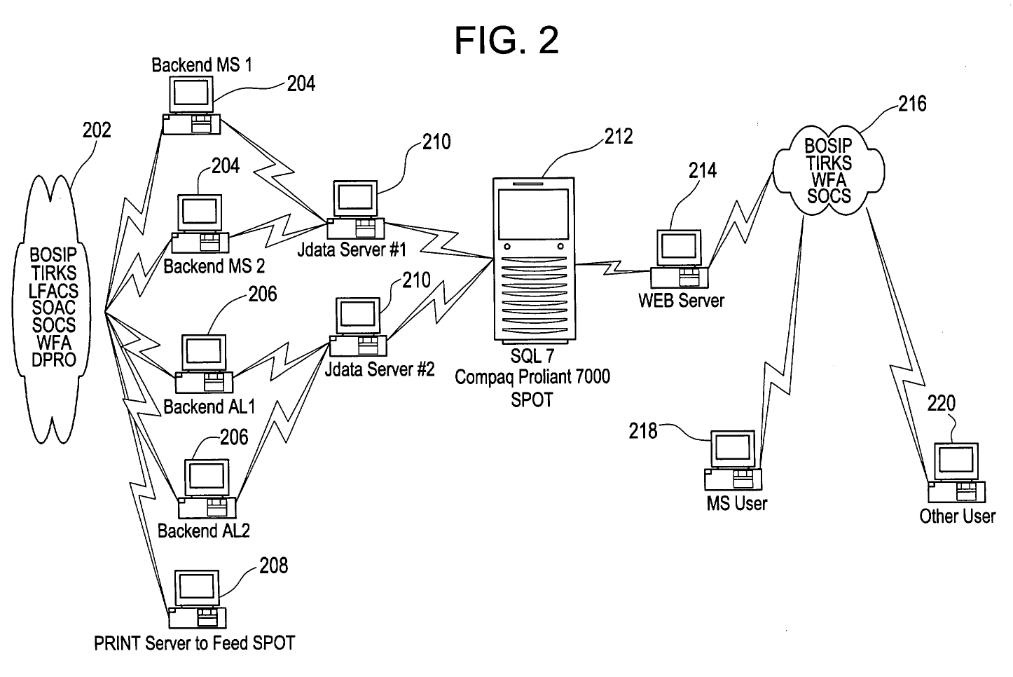

FIG. 2 is a block diagram of an alternate exemplary system for performing strategic priority order tracking. The SPOT system is executed on a structured query language (SQL) compliant host system 212 (e.g., SQL 7 running on a Compaq Proliant 7000). The host system 212 is connected to a web server machine 214 and includes the SPOT application program and database. Microsoft compliant user systems 218 and non-Microsoft compliant user systems 220 (e.g., UNIX compliant) are connected to the network 216 to access the SPOTS application, along with the BOSIP, TIRKS, WFA and SOCS applications, either through the SPOTS application or directly. As shown in FIG. 2, the back-end to the host system 212 includes one or more Java data servers 210 which are fed legacy system data via back-end Microsoft systems 204 and the back-end Alabama system 206, that monitors Alabama orders. The Java data servers 210 collect data from the legacy system databases via a network 202 (e.g., an intranet). FIG. 2 also includes a print server 208 that receives print traffic, strips data, and then delivers print traffic to the SPOT database and to the users systems 218, 220.

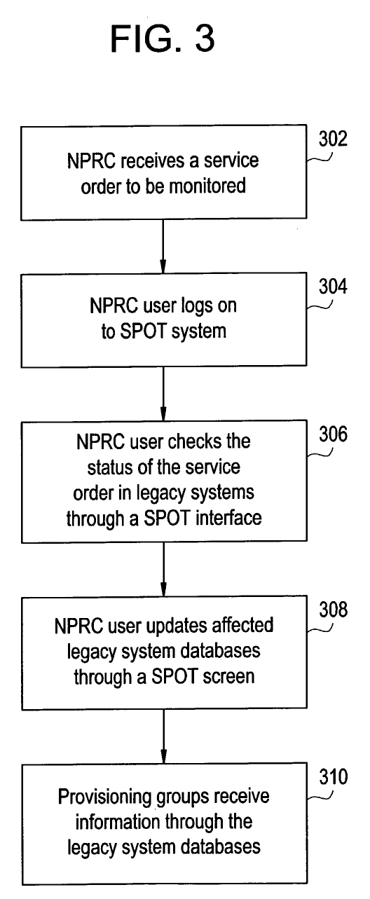

FIG. 3 is an exemplary high-level process flow for performing strategic priority order tracking. At step 302, the NPRC receives a service order to be monitored. Next, an NPRC representative logs on to the SPOT system via a user system 102 at step 304. This is done via the network without the need for any additional software on the user's computer. At step 306, the NPRC representative checks the status of the service order in all affected legacy systems through a single SPOT interface via a user system 102. The legacy systems include a collection of databases accessed by the NPRC, such as those shown in FIG. 1. The web server then performs a series of tasks in the background. First, the web server accesses the SPOT database and obtains the information from the database, which includes information that has been collected from the legacy systems. Next, the web server sends the information on the order back to the user on a single screen accessible via the user system 102, which presents the information in a user-friendly interface that is easily managed. In addition, to a NPRC representative, another SPOT user, such as a customer, may be allowed to access SPOT to view the status of the customer order. Security would be provided to prevent the customer from viewing orders that are associated with other customers. In addition, security may be provided to prevent a NPRC representative from viewing the order status of orders belonging to direct competitors in the region supported by the NPRC.

At step 308, the NPRC user updates affected legacy system databases through a SPOT user interface screen. Additionally, the user can input notes into the SPOT system and choose where the information is to be sent (i.e., to which legacy system(s)—TIRKS, SOCS, and/or WFA/C). The user can also send a Firm Order Commitment (“FOC”) and modify dates on an order through SPOT, whereas these functions could previously only be done by multiple legacy transactions. Additionally, the user may update the legacy systems through a single SPOT screen, alerting key provisioning groups and making follow-up telephone calls as necessary. At step 310, the appropriate provisioning groups receive the necessary information through the legacy database(s) to which they have access and perform the necessary work accordingly. An exemplary embodiment of the present invention further provides all provisioning groups with the ability to forecast load-balancing and work effort within their areas in order to meet Intermediate Critical Dates (ICDs) and CDDs. The provisioning groups may include Plug-In Control System (PICS), WMC, Address and Facility Inventory Group (AFIG), Circuit Capacity Management (CCM), SAC and Contract Engineer, Interstate Carrier Service Center (ICSC), ACAC, Business Repair Center (BRC), and CPG. The Construction/Project Engineer may also receive such information.

PICS provides a mechanized process for the administration of plug-in equipment acquisition, movement, repair, and retirement. WMC is responsible for dispatching inside (central office and center) technicians and outside technicians to meet service dates. AFIG maintains inventory of the LOOP cable and electronics (LOOP is a term used to describe the facility or transport medium that delivers service from a central office to a customer location) and makes assignments on a service order to define the transport medium from the central office to the customer's location. SAC is responsible for resolving facility situations to insure that the correct transport medium is available in time to meet a customer's service order. The Contract Engineer is an outside plant engineer who performs functions similar to SAC. ICSC issues service orders for access and wireless services and interfaces with the external customer. ACAC is responsible for the overall control and acceptance testing of an access customer's service. BRC is responsible for the overall control and acceptance testing of a BBS non-access customer's service. CPG designs a customer's service by interpreting the service order, validating the LOOP transport medium assigned to the order by the AFIG/SAC, and validating the interoffice transport and central office equipment provided by CCM.

The SPOT system is an avenue through which information is placed in an efficient manner into the legacy systems and SPOT is broadcasting that information into the legacy systems. Each provisioning group may only access one or two legacy systems rather than all of them. Once the provisioning groups have this information, they can complete the work or tasks set forth on the particular service order. The SPOT system may also be configured to allow a user to post a remark to multiple legacy systems, which saves the duplicate effort of providing remarks into multiple systems individually.

As part of an order tracking system, the NPRC is notified of orders falling in certain product categories. Additionally, the NPRC is notified of orders that are in danger of not being completed by specific due dates. The SPOT system searches the legacy systems looking for particular information in which the NPRC is interested regarding certain orders. In an exemplary embodiment of the present invention, the SPOT system collects the information needed by the NPRC from the legacy systems through a method called screen scraping, which involves the use of a program to read and evaluate data shown in the legacy terminal screens that replicates the process that a person would follow in analyzing multiple terminals. The system knows the information it is looking for and where it is located within the different fields within each legacy database, so it retrieves the information and then downloads it to the SPOT database for storage. The system copies the information to the SPOT database and does not remove information from the legacy databases.

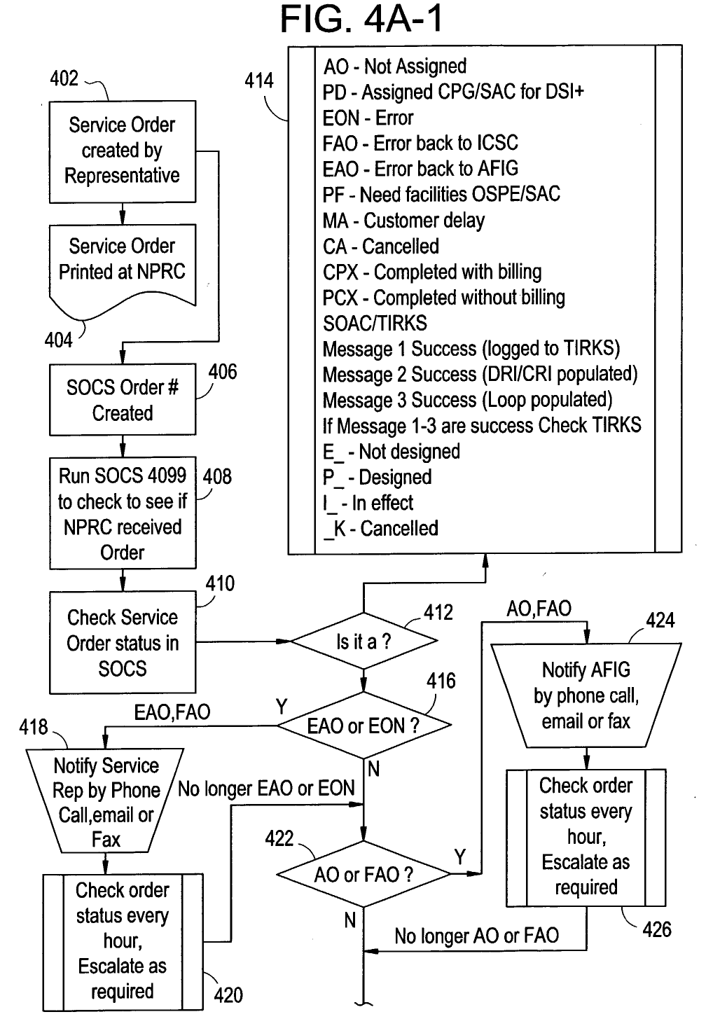

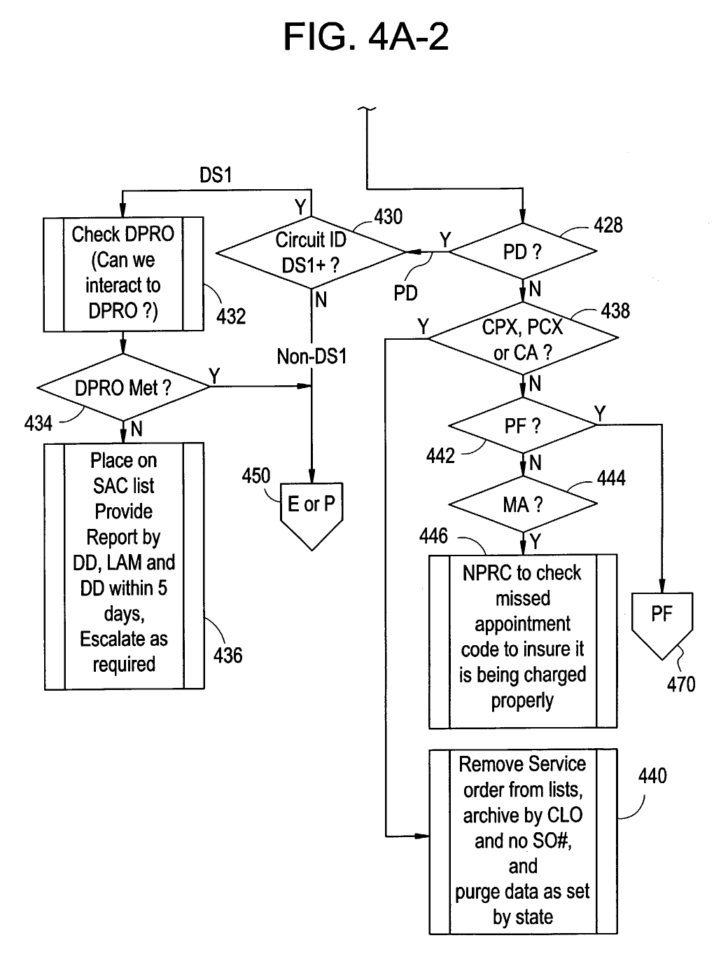

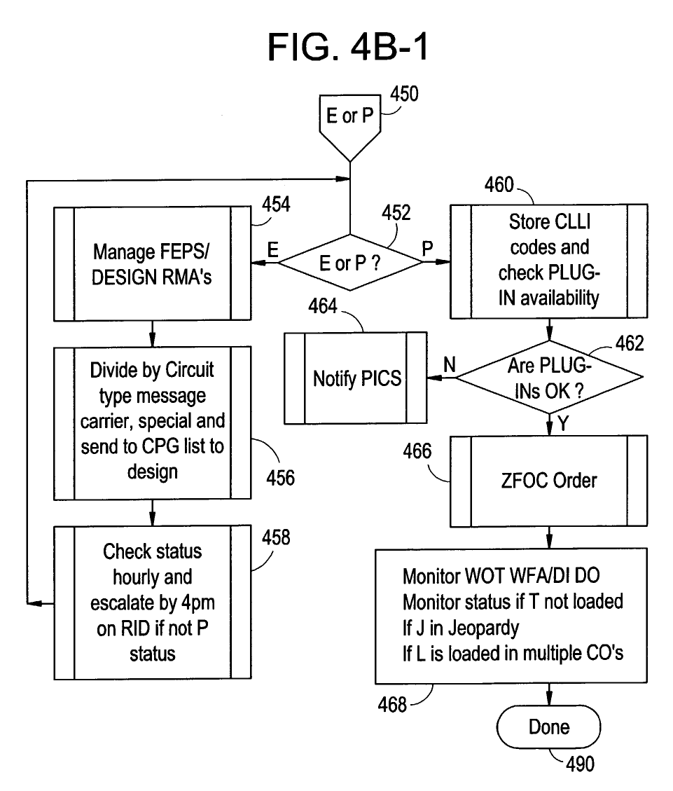

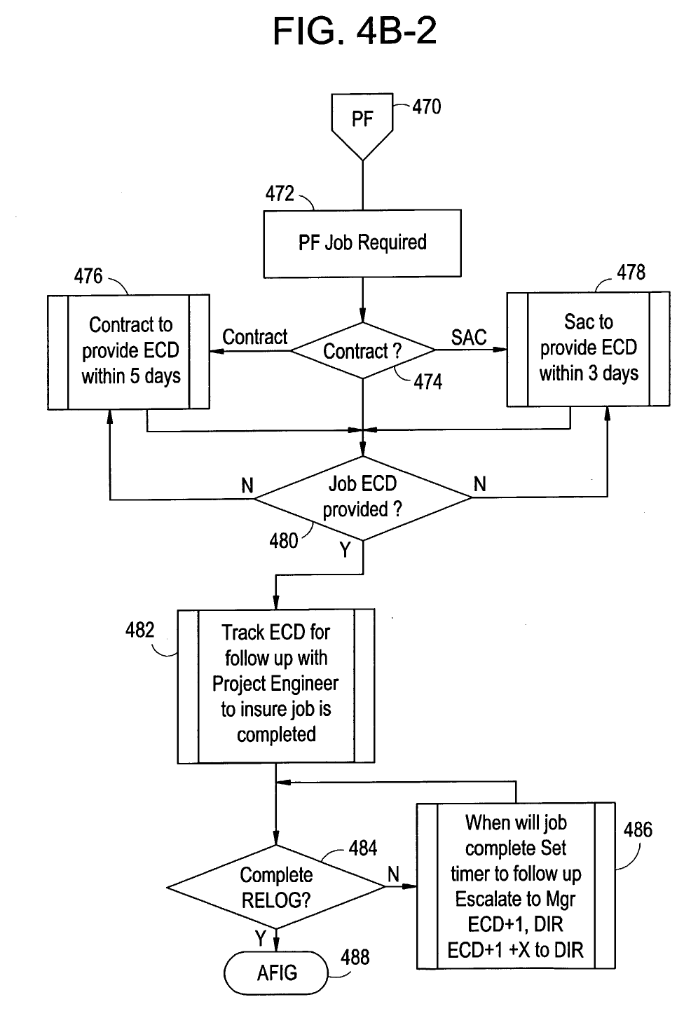

FIGS. 4A and 4B depict the order tracking and troubleshooting process flow that occur within the SPOT system. At step 402, a service representative issues a service order in the SOC system and, at step 406, assigns a service order number to the customer request for service. The service order flows from SOCS to downstream users such as the NPRC, and legacy systems such as LFACS, SOAC, TIRKS, and WFA. At step 404, the system receives a copy of the order, enters the order into an order entry database table to begin tracking the order, and redelivers a paper copy of the order to the NPRC. At step 408, the system generates a SOCS 4099 forecasting report to add orders to the system which were not delivered to the NPRC printer feed. Next, at step 410, the system will check the current status of all pending orders using terminal emulation in SOCS. This allows for categorization and prioritization of service orders. The system determines at step 412 what the status of the order is among the choices listed in box 414. The order status is used to determine which provisioning group in the overall process is currently responsible for the order.

At step 416, if the status is EAO (error back to AFIG) or EON (error), both indicating that an error was found on the order, a service representative is notified and the system does not check other legacy databases at step 418. At step 420, the status of the order is checked every hour and escalated as required, until the status is cleared. If the error is not cleared in time to meet the assigned service dates, the NPRC will escalate the error for resolution. At step 422, if the status is AO (not assigned) or FAO (error back to ICSC), AFIG is notified to resolve the status condition at step 424 and the status of the order is checked every hour and escalated as required at step 426, until the status is cleared. At step 428, if the status is PD (assigned CPG/SAC for DS1+), then at step 430 it is determined whether the circuit ID is DS1+. If not, then the method proceeds (through 450) directly to step 452 (FIG. 4B), where a determination is made whether the status of the order is E (not designed) or P (designed). If the circuit ID is DS1+, then, at step 432, DPRO is checked to ensure that design information for the local OSPE controlled LOOP is received. At step 434, if DPRO is met, then the method proceeds directly to step 450. If not, then at step 436, the order is placed on the SAC list provide report and escalated as required.

If the status of the order is not PD at step 428, then the method proceeds to step 438 where it is determined whether the status is CPX (completed with billing), PCX (completed without billing), or CA (cancelled). If the status order meets any of these criteria, then, at step 440, the service order is removed from lists, archived, and set for purge (once it has aged for six months). If the status of the order is PF (need facilities OSPE/SAC), then the method proceeds directly to 470 (FIG. 4B). At step 444, if the status of the order is MA (customer delay), the method proceeds to step 446 where the NPRC checks the missed appointment code to insure the order is being charged properly.

As shown in FIG. 4B, if the status is PF, then in step 472, a PF job is required where internal construction groups build a facility transport route to serve this customer. At step 474, it is determined whether engineering for this job to provide a facility transport for this order is to be carried out by the Contract Engineer or SAC. If the Contract Engineer is responsible, then an Estimated Completion Date (ECD” is to be provided within 5 days. In step 478, if SAC is responsible, then an ECD is to be provided within 3 days. At step 480, it is determined whether ECD was provided as required. If not, then the method returns to either step 476 or 478, according to whether the Contract Engineer or SAC is responsible for the order. If the ECD is not provided within the allocated time frame, the NPRC will escalate to the SAC or Contract Engineer. Once the ECD is provided, it is tracked by the system (and the NPRC) for follow up, at step 482, with the Project Engineer to insure that the PF job is completed, and it is escalated if the commitments are not met. At step 484, it is determined whether a Referred to Engineering Log (RELOG) is complete. At step 486, the system monitors the AFIG's RELOG list for an order to determine ownership in the provisioning process. Once the AFIG Engineering Work Order (EWO) group completes their tasks associated with the order, the order may be moved into the LFACS system and leave PF status. If RELOG is complete, as determined at step 484, then AFIG is contacted at step 488 to complete processing of the order by creating the requested facilities in LFACS. If not, then at step 486, escalation timers are set to further completion of RELOG and the method proceeds back to step 484 to determine is RELOG is complete after a specified period of time.

Returning to FIG. 4A, once the circuit ID is determined to be non-DS1, either in step 430 or step 434, the method proceeds through 450 to step 452, shown in FIG. 4B, to determined whether the status of the order is E (not designed) or P (designed). If the status is E, then designs referred for manual assistance (RMAs) and Facility and Equipment Planning System (FEPS, a TIRKS module) failures, if any, must be resolved at step 454. At step 456, a list is then sent to CPG with all of the necessary parameters for designing the appropriate circuitry. At step 458, the status is checked hourly and escalated accordingly until the design is complete and the status is changed to P.

Once the status of the order is P, the method proceeds to step 460 where CLLI codes (codes that define a physical location to the detail of frame, floor, building, address, city, and state) are stored and plug-in availability is checked further at step 462. If plug-ins are not able to be established, then PICS is notified at step 464. Once this condition is met, the status of the order is changed to a ready-for-ZFOC condition in the system at step 466. “FOC” stands for firm order confirmation and putting a “Z” in front of it identifies it as a SOCS filed identifier. This is utilized as a signal to the customer that RBOC is committed to the dates and that if the date is missed installation costs may be refunded. The process of inserting the “Z” occurs in the SOCS legacy system. The ready-for-ZFOC condition represents BellSouth's commitment to meet a customer's service date and is a code added to a service order by a user or by the system itself. The status is further monitored at step 468 until the service order is completed at step 490.

In an exemplary embodiment of the present invention, escalation timers may be customized in order to notify NPRC users if CDD, any designed order, or ICD is at risk. This assists the provisioning process because the warnings and escalation notices are available to users as conditions occur to create these warnings and escalations. Currently, users must collect the data from multiple systems, on average 95 host transactions, and analyze the data on a periodic basis to determine if orders need additional processing or escalation to a higher level of importance. Additionally, the system collects real-time metrics to support performance analysis. To do this, the SPOT application stores a time stamp and a snapshot in time for an order. This allows a root cause analysis to be built for each order. SPOT stores this analysis in case of a failure. When an event is scheduled, SPOT notifies the NPRC to escalate it accordingly from a first escalation level to a third escalation level, indicating the highest priority, and the details are stored in the database.

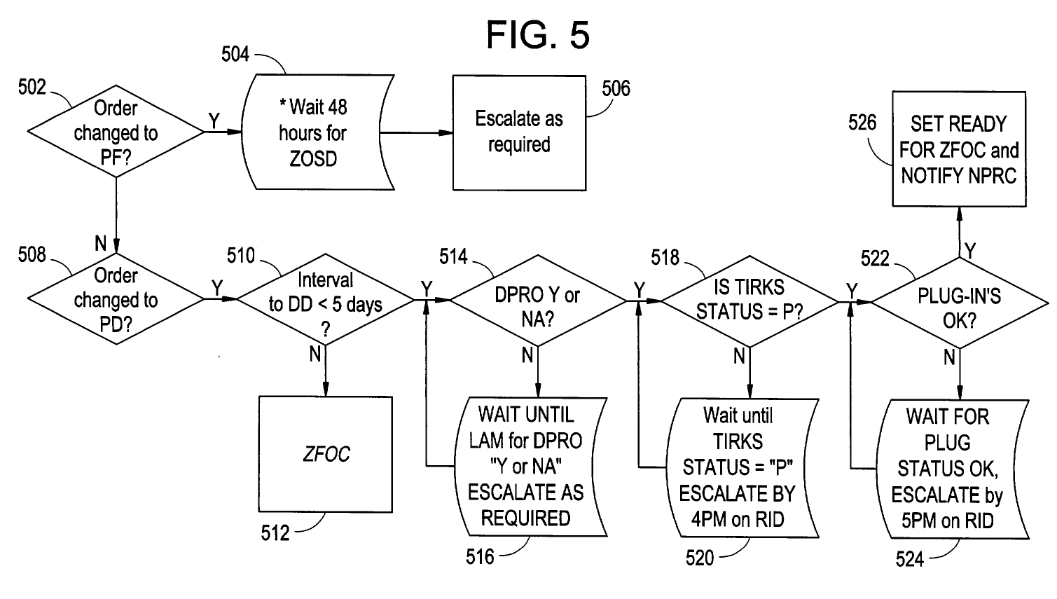

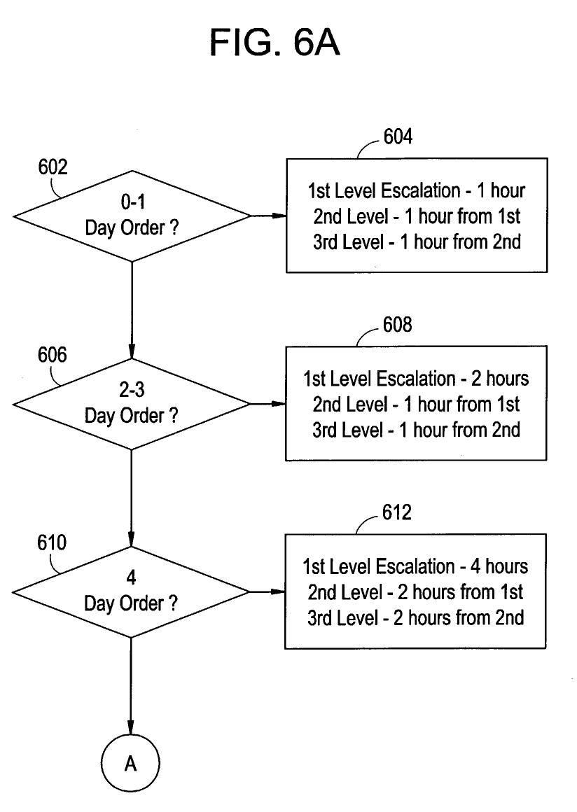

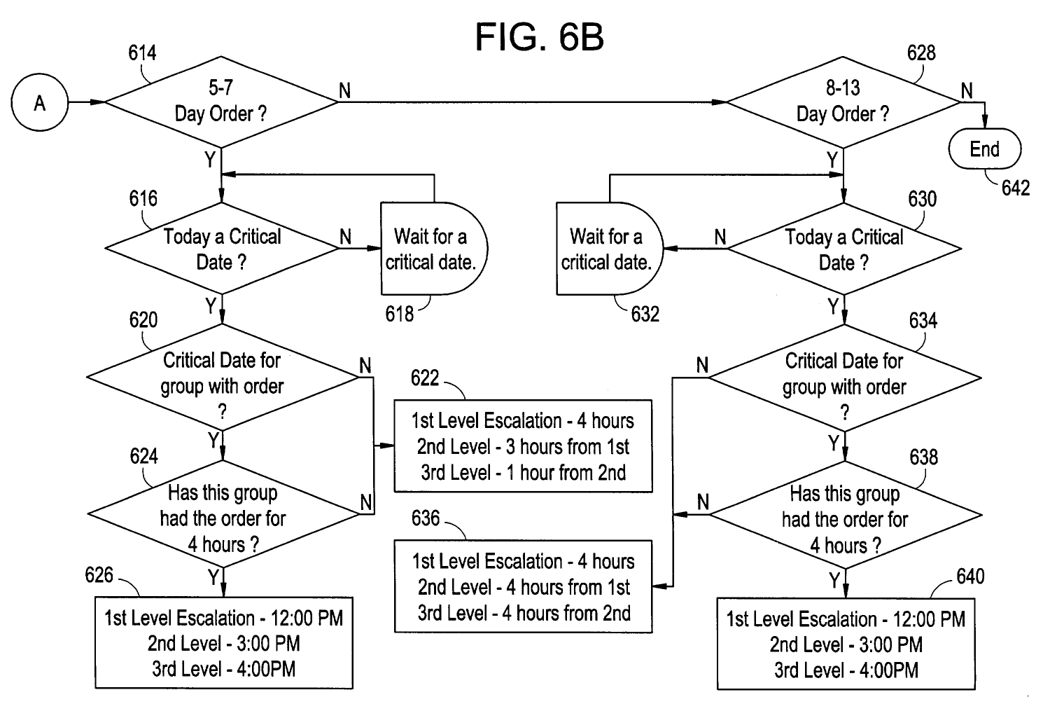

FIGS. 5, 6A, and 6B show embodiments of the order escalation process and logic within the SPOT system. In FIG. 5, at step 502, a determination is made whether an order is PF status. If so, then at step 504, the order waits for forty-eight hours until ZOSD (a code on the service order that represents the service date on a particular job for a service order) and is then escalated as required at step 506. If the order status is not PF, then the method queries whether the order status is PD at step 508. If so, then a determination is made at step 510 whether the due date is less than five days away. If not, then the order is given ZFOC status at step 512. If the due date interval is less than five days, then it is determined whether the order status with DPRO is “Y or NA” at step 514. If not, then at step 516, the system waits until the ICD Loop Assigmnent Met (“LAM”) is completed, such that the status with DPRO is “Y or NA.” The method escalates this order as required in order to meet any promised critical dates. If DPRO status is “Y or NA,” then it is determined whether the TIRKS status is P (designed) at step 518. If not, then the system waits until TIRKS status is P and escalates the order as required at step 520. At step 522, if TIRKS status is P, then it is determined whether plug-ins are acceptable. If not, then the system waits for plug status to be satisfied and escalates the order as necessary at step 524. Once plug-in status is met, the order is ready for ZFOC and the NPRC is notified at step 526.

FIGS. 6A and 6B provide embodiments of escalation logic that could be used within the SPOT system for orders that must be completed within zero to thirteen days. Many alternative embodiments will be obvious to those skilled in the art. All first level escalations are from the time when the provisioning group first receives the order. At step 602, it is determined whether the order must be completed within one day. If so, escalation occurs as shown in step 604, first level escalation one hour after the provisioning group receives the order, second level escalation one hour later, and third level escalation one hour after the order receives second level escalation. If an order is required to be completed in two to three days, as shown in step 606, then escalation occurs as in step 608 with first level escalation after two hours, second level escalation after one more hour, and third level escalation after an additional hour. In step 610, it is determined whether an order must be completed in four days. If so, escalation is carried out as in step 612 where first level escalation occurs after four hours, second level after two more hours, and third level two hours after second level escalation.

Referring to FIG. 6B, if an order must be completed within five to seven days, the method proceeds from step 614 to step 616, where it is determined whether today (the day the order is being examined) is a critical date. If not, the system proceeds to wait for a critical date at step 618 before returning to step 616. If today is a critical date, then the method proceeds to step 620 where it is determined whether the critical date is for the provisioning group who currently has the order to perform the required service. If not, then escalation of the order occurs as shown in step 622 where first level escalation is after four hours, second level escalation is three hours later, and third level escalation is one hour after second level escalation. If the provisioning group is the group responsible for seeing that the pending critical date is met, then it is determined whether the group had the order for more than four hours at step 624. If not, then the method proceeds to step 622 and the escalation occurs as shown there. If the group has had the order for more than four hours, then the method proceeds to step 626 and first level escalation occurs at noon, second level occurs at 3:00 p.m., and third level occurs at 4:00 p.m.

At step 628, the system determines whether an order must be completed with eight to thirteen days. If not, then the methods ends as shown in step 642. At this point, an order has passed through the system such that we now know that it is not due any time within the next thirteen days. For such orders, the system will automatically poll each required Legacy database, tracking the status and critical dates, and escalate if required.

For orders that must be completed within eight to thirteen days, it is determined whether today is a critical date at step 630. If not, the system proceeds to wait for a critical date at step 632 before returning to step 630. If today is a critical date, then the method proceeds to step 634 where it is determined whether the critical date is for the provisioning group who currently has the order to perform the required service. If not, then escalation of the order occurs as-shown in step 636 where first level escalation is after four hours, second level escalation is four hours later, and third level escalation is four hours after second level escalation. If the provisioning group is the group responsible for seeing that the pending critical date is met, then it is determined whether the group had the order for more than four hours at step 638. If not, then the method proceeds to step 636 and the escalation occurs as shown there. If the group has had the order for more than four hours, then first level escalation occurs at noon, second level occurs at 3:00 p.m., and third level occurs at 4:00 p.m. as shown in step 640.

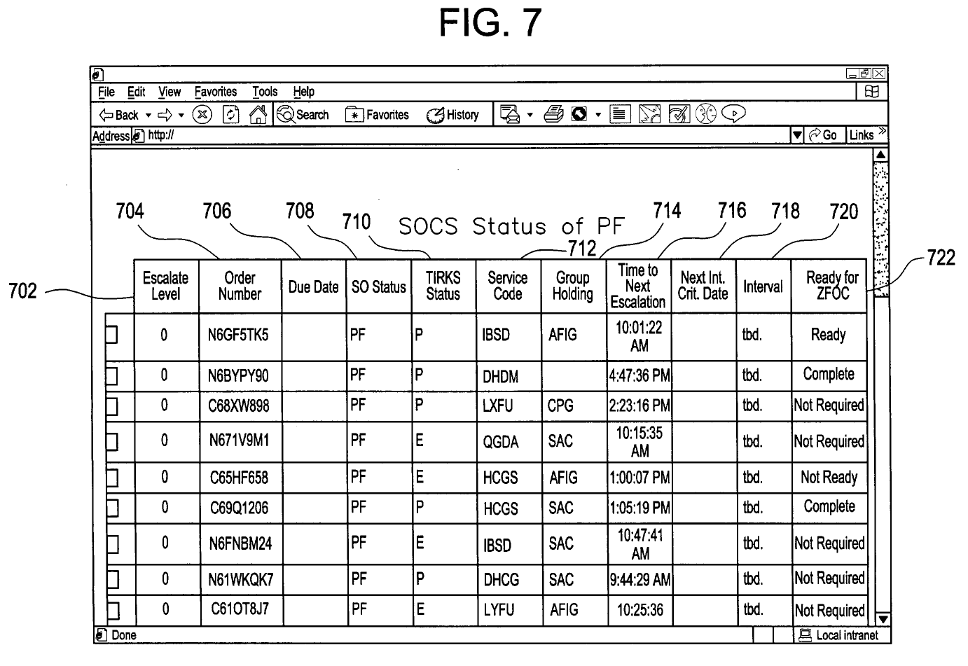

FIG. 7 is an exemplary user interface screen for listing work orders, with numerous characteristics for each order. When a user logs on to the SPOT system, he sees a user interface screen with a list of work orders, such as that shown in FIG. 7. FIG. 7 depicts a list of work orders, with numerous characteristics for each order such as escalate level 702, order number 704, due date 706, SO status 708, TIRKS status 710, service code 712, group holding 714, time to next escalation 716, next ICD 718, interval 720, and ready for ZFOC 722. The FOC designation is input into the system which alerts the ICSC, who talks to telephone companies such as AT&T or MCI and tells them when the order will be ready, met, and so on.

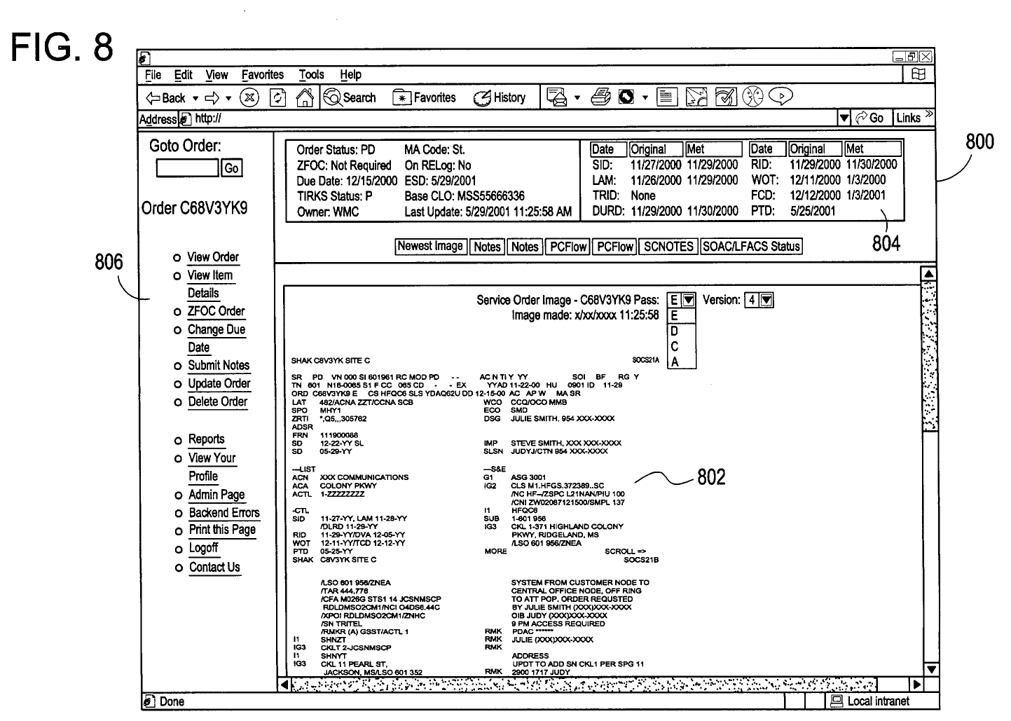

FIG. 8 is an exemplary user interface screen for displaying detailed information for a particular order. The user selects an order number 704 from the user interface screen depicted in FIG. 7. The web server then gets the information from the SPOT database. The SPOT database contains the order status information that has been collected from the legacy system databases. The web server sends the information on the order back to the user on a order detail screen 800 displayed on the user system 102, as shown in FIG. 8. FIG. 8 shows a detailed display of information for a particular order through a single order detail screen 800 in the SPOT system. The order detail screen 800 depicted in FIG. 8 includes a order status summary section 804, a user selection menu 806 and a detailed display section 802. The user would select from the user selection menu 806 to perform functions such as: view or make updates to the current order, create a new order, create reports, print and perform administrative updates.

Additionally, the user may input notes into the SPOT system and choose where that information is sent (i.e., to which legacy system(s)—TIRKS, DPRO, SOCS, and/or WFA/C). Further functions may include viewing current or previous versions of the service order, view order details (e.g., critical date progress, status information, owner, the DPR), drill down into item information (e.g., that contains data such as OSSLOG plug-ins, TFAS, WFA-DO log and status, WFA-DI log and status information). OSSLOG is the name of a format screen in the WFA/C legacy system. The screen stores a history of the events that take place in the provisioning service. TFAS stands for TIRKS field assistance system and is a subsystem of the TIRKS system. TFAS is utilized to track calls made from the field on design related problems encountered in provisioning the service. By utilizing the SPOT system, a user may update information for a particular order in one or all of four of the SOCS, TIRKS, DPRO and WFA/C legacy systems, simultaneously. SPOT interacts with SOCS, TIRKS, DPRO and WFA/C in real time, so that the user does not have to leave the SPOT system to provide updated information to the legacy databases.

The user may also change dates or send a FOC through the system via a SPOT user interface screen. The SPOT application will allow a user with the proper security level to change dates on the service order and to populate an associated note in SOCS, WFA and TIRKS that includes the users CUID, date, time and any additional text added by the user. SPOT notifies the user once the update has been completed. The dates the user may change includes dates such as: SID, LAM, RID, DVA, WOT, FCE and PTD. SID stands for scheduled issue date and is the date that the service order should be issued so that other groups have a document to work from. SID is an intermediate critical date assigned to insure that the RBOC processes an order in the provisioning process from department to department, and that the RBOC stays on track to meet the customer due date. PTD stands for plant test date and is the date when the RBOC should have done a pre-test before releasing the service to the customer to insure that it will work when it is turned over to the customer on the due date. The SPOT system will allow a user with the proper security level to FOC (also referred to as ZFOC) the service order through a user interface screen and populate a note in SOCS, WFA and TIRKS that includes the user's common user identification (CUID), date, time and any additional note added by the user. The SPOT application notifies the user once the FOC has been completed. If the user chooses the update order option from the user selection menu 806, the data relating to the order will be updated, or refreshed by the SPOT system, based on the latest date contained in the legacy databases and a message will be sent to the user when the update is complete.

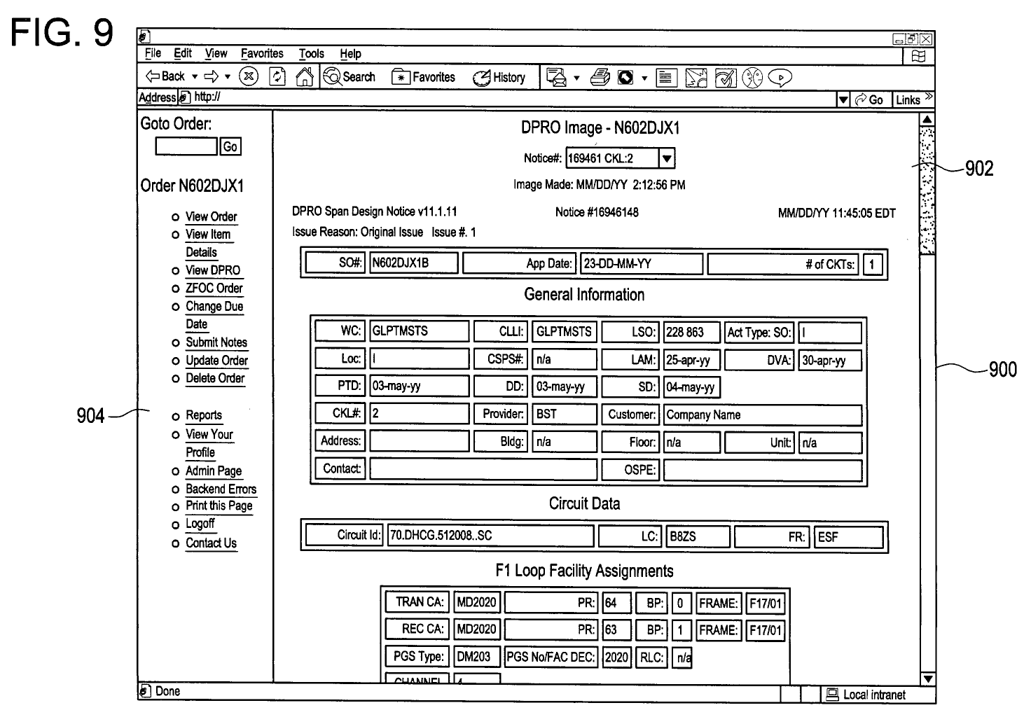

FIG. 9 is an exemplary user interface screen for displaying DRPO data via the SPOT application program. DPRO sends information to the SPOT system and this information may be displayed through the SPOT application in a manner such as the one depicted in FIG. 9. The SPOT application links all revisions of the DPRO to the order. The DPRO document (e.g., a word document) is linked into the SPOT system and the user is not required to log into the DPRO legacy system in order to view the document. The DPRO data user interface screen 900 includes a user selection menu 904 and a DPRO report section 902. The DPRO report section 902 includes heading information about the order, as well as general information, circuit data and F1 loop facility assignment. The other sections of the standard DPRO report would be made visable to the user via a standard scroll bar. Word documents from other sources may be viewed via the SPOT system in a similar manner.

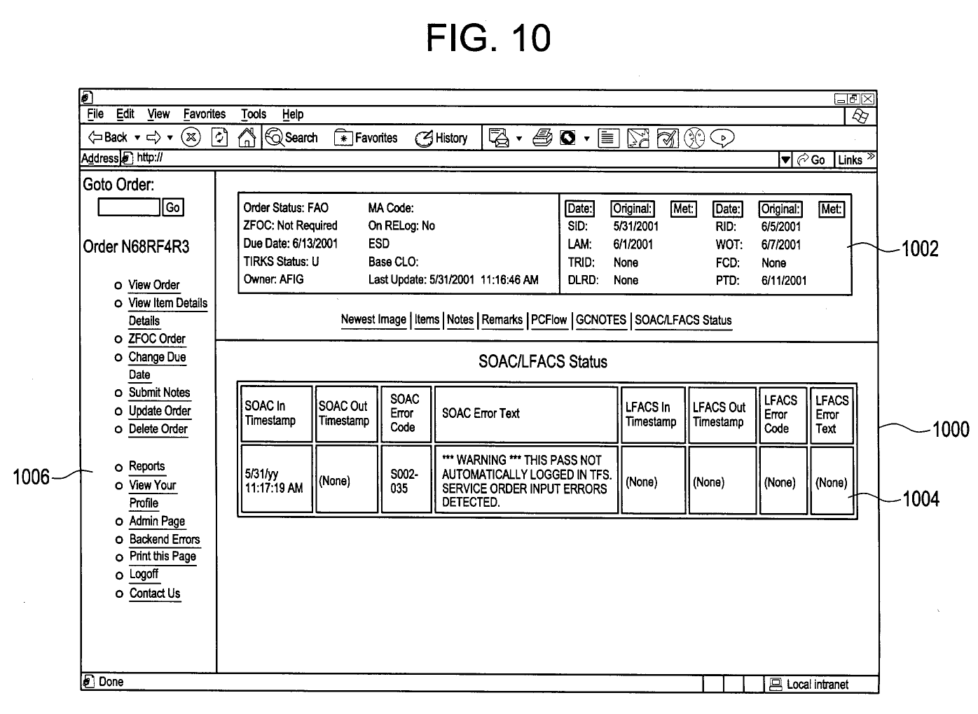

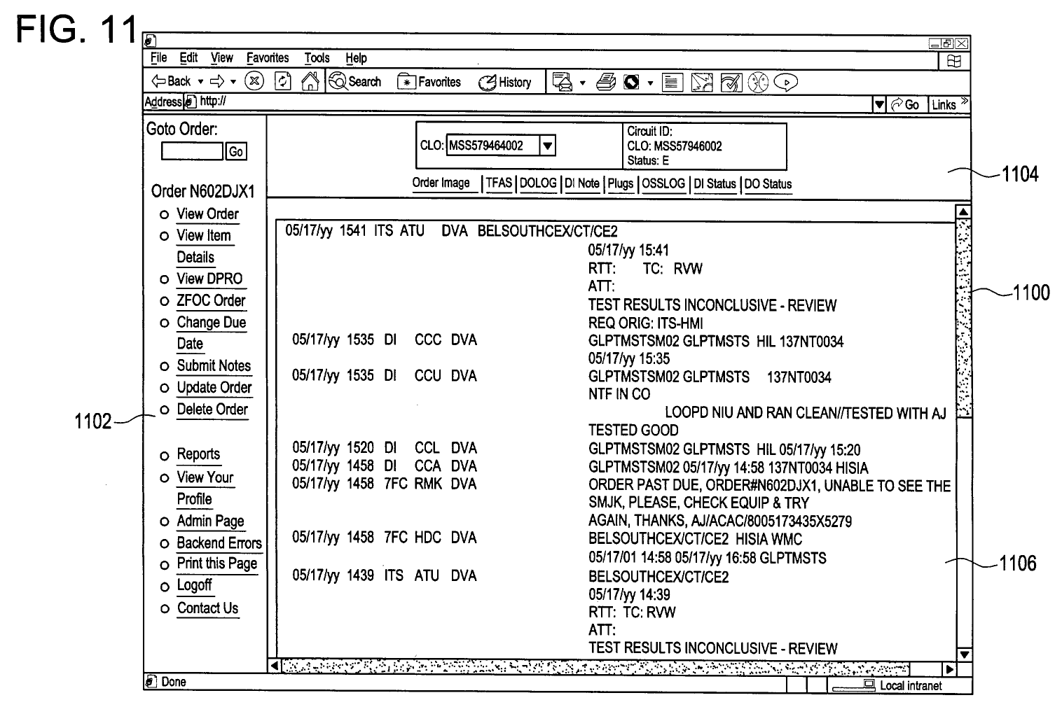

FIG. 10 is an exemplary user interface screen for displaying SOAC and LFACS errors via the SPOT application program. The SOAC and LFACS error screen 1000 includes a user selection menu 1006, an order status summary section 1002 and a SOAC/LFAC status section 1004. In this manner, a user may have visibility to the errors flagged by the SOAC and LFACS systems. FIG. 11 is an exemplary user interface screen for displaying a WFA log for a particular order via the SPOT application program. The WFA log user interface screen 1100 includes a user selection menu 1102, a heading information section 1104 and a log details section 1106. The log details section 1106 includes a display of the WFA OSSLOG. This allows a user to view activity that has occurred on the WFA system. In addition, a user may view the WFA-DI status via a SPOT user interface screen. The DI status may include fields such as location; assigned status; jeopardy; wired office tested (WOT) status; WFA number; type (e.g., PCATH, PCAFH); ID; early start, late start and associated report; and escalation and associated report. Other user interfaces provided by SPOT may include displaying the current plug-in status for each item on the order and displaying the WFA-DO status for an order.

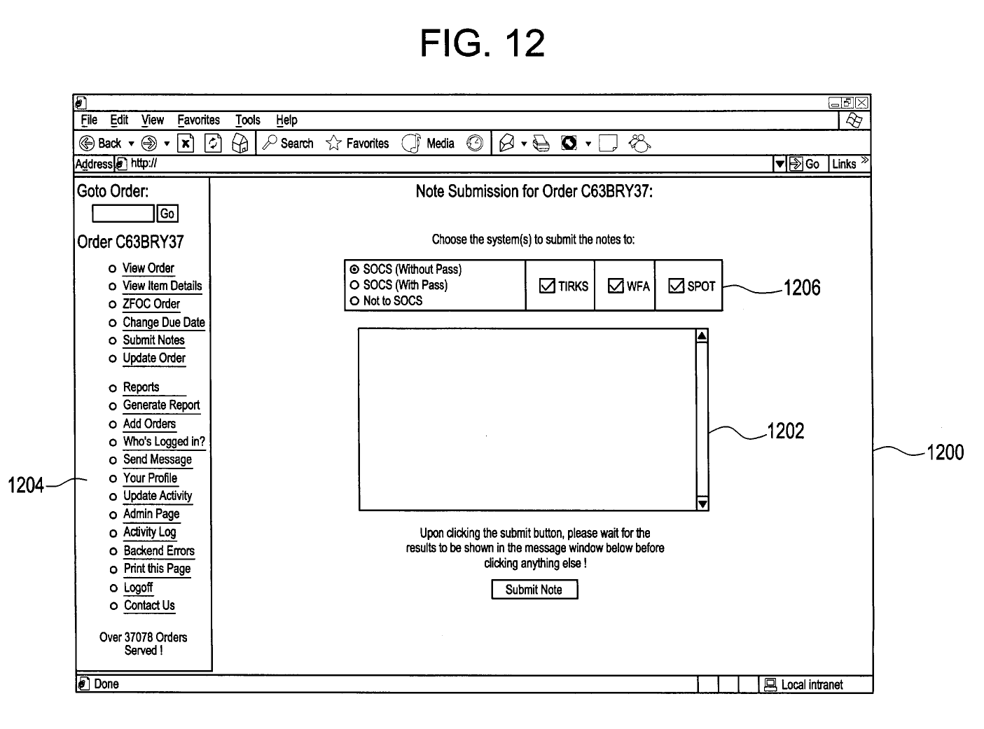

FIG. 12 is an exemplary user interface for submitting a note to legacy systems via the SPOT application program. The submit note user interface screen 1200 includes a user selection menu 1204, a note submission area 1202 and a system selection menu 1206. The system selection menu 1206 allows the user to select which systems will receive the note. By entering a note in the note submission area 1202 and submitting the note, the note is propagated to WFA, SOCS, TIRKS and SPOT depending on what the user selects in the system selection menu 1206.

The SPOT application may also include an instant messaging facility for communicating with another SPOT user. The SPOT application notifies a user if the user is viewing an order in use by another user and then allows the user to send an instant message to the other user. If the other user has logged off, then the message is sent to a queue for the other user to view during the next session. The sender will be notified if the message has been sent to the queue. Another function is the ability to add multiple orders for tracking by SPOT. Though SPOT discovers most orders by running regular reports (e.g., hourly, daily) against SOCS, at any time a user may paste a list of orders into a multiple order processing user interface screen to invoke tracking by the SPOT system. The list of orders may be pasted from a spreadsheet application (e.g., EXCEL).

The SPOT application may produce project based reports. A project code may be assigned to different bundles of work. The user may type in a project number and the SPOT application will gather everything with that specified project code. In addition, a project manager may have an EXCEL spreadsheet with a list of order numbers. This EXCEL spreadsheet may be pasted into SPOT and SPOT will return a summary with the current status information for each order included in the spreadsheet or for orders that are associated with a specified project number. Any remote database or text document may be accessed via SPOT for read only. The additional data may be required by the user to make a decision about the best course of action for a particular order.

User defined and created reports may be supplied through the SPOT system. The user may create a report by selecting particular fields, filter requirements and a sort order from a form presented via a user interface screen that lists all elements included in the database(s) selected by the user. By using the form, no specialized code is required to create a new report. The end user from the application page, can select which fields that they want to display in their reports, and combine any number of existing reports to define exactly what they are looking for. The end user may also filter their reports on several key fields such as: customer, dates and service representative sales code. Administrators can create custom reports using the Transact SQL language by populating in a database table the view/database and their where clause. The application will dynamically link all reports from the table in the database. No custom coding is required to add new reports to the application. The user created report could be saved in a user defined report directory. In addition new reports may be created based on a combination of existing reports or existing reports with specific date ranges may be executed by the user.

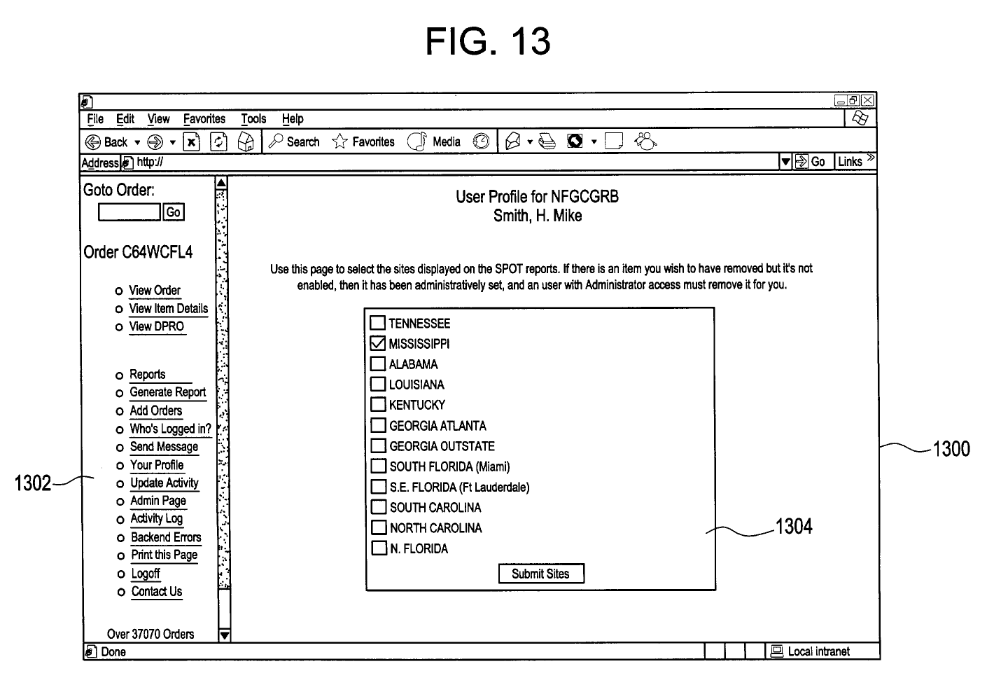

FIG. 13 is an exemplary user interface for performing user administration functions. The user administration user interface screen 1300 includes a user selection menu 1302, and a user profile section 1304. SPOT has two levels of administration, the first controlled by a SPOT administrator, the second by the user. A user may customize the type of data returned in reports, but can't remove settings entered by their administrator. This way if a supervisor assigns order types or turf assignments to insure all areas of the work are covered and eliminate two people working on the same problem, a user will not be permitted to create gaps. The user may only add to their profile. The user profile section 1304 depicted in FIG. 13 includes a list of sites associated with orders. Once the user has selected a site (e.g., Mississippi), a list of districts within the site would be displayed for the user to select from for addition to the user profile.

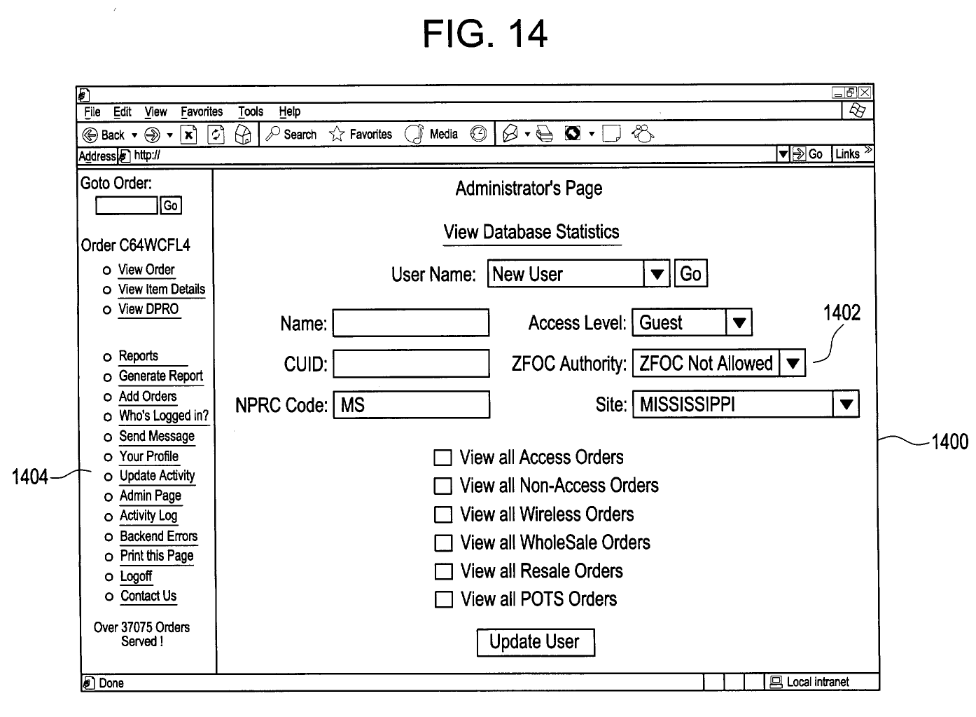

FIG. 14 is an exemplary user interface for performing system administration functions. The administrator user interface screen 1400 includes a user selection menu 1404 and a administrative data section 1402. The administrative data section 1402 allow an administrator to view and/or update the access provided to a particular SPOT user. Additionally, an administrator may view a list of all orders being updated, an activity log, a SPOT error display (each entry includes for example, a synthetic key, a timestamp, a message, a tree and a stack trace, and SPOT database statistics including service order statistics and possible problems (e.g., a list orders that did not show up in the reports, orders that don't have owners and orders that don't have districts).

An exemplary embodiment of the present invention has been described with reference to specific order tracking and provisioning legacy systems and databases. An alternate exemplary embodiment of the present invention may utilize other legacy systems as long as they provide the data to perform the process depicted in FIGS. 4A and 4B. An exemplary embodiment of the present invention may be utilized to improve customer satisfaction and increase revenue. The NPRC and other similar centers may become more efficient, resulting in reduced overtime and headcount, and employees produce higher quality work upon the elimination of the existing manual inquiry and tracking. Another advantage is that the SPOT system is web-based, as opposed to software-based. This means that installation on individual PCs and PC problems do not affect the system and less individualized maintenance is required. In addition, the ability to split SPOT processing between multiple CPUS and to split the SPOT database into multiple databases may lead to improved throughput in the SPOT system.

By automating most of the manual work of collecting data in the existing process, an exemplary embodiment of the present invention relieves pressure on NPRC users. An exemplary embodiment of the present invention also improves the CDD success rate and the provisioning process. The ability to send instant messages to other users may lead to less overlapping work being performed. In addition, the ability to pull documents, spreadsheets and remote databases into the SPOT system may lead to better business decisions. The SPOT system allows for better prioritization and escalation, which improves ICD completions and cuts down overhead and overtime costs of these groups associated with rushing to complete a job. Improvement in each ICD completion has a positive ripple effect on subsequent ICD completions in the same work order. Additionally, automatic prioritization of orders allows the NPRC to target escalation in the correct order and thereby improve CDD completion percentage levels.

An exemplary embodiment of the present invention allows the NPRC to process the current volume of orders in less time, providing the NPRC additional time to perform better follow up on orders and to take on other types of orders using the same resources. The SPOT system provides standard reports but also provides the users with an efficient tool for creating customized reports. These customized reports may be created by the user without the need for application programmer assistance. In this manner, a user may easily customize the viewing of the SPOT data. The SPOT system allows for collection of critical data that enables the NPRC and other groups to perform root cause analysis for delayed orders and analyze their productivity. Improvement in the overall provisioning process results from improvement in the performance of ICDs (such as LAM, Record Issue Date (“RID”), and Wired Office Tested (“WOT”)), improvement in FOC performance for the network center, and improvement in CDD performance.

With an exemplary embodiment of the present invention, NPRC users do not have to spend time recording statuses on paper, organizing paper files, and struggling for prioritization. An exemplary embodiment of the present invention collects the status of all service orders within one hour of real time and prioritize the service orders to be escalated. This allows NPRC users to concentrate on making phone calls for escalation and following up with various provisioning groups. Additionally, with increased efficiency, more time is available for current NPRC users to track and manage BBS service orders as well as other kinds of service orders. The ability to view DPRO data from the SPOT system may lead to increased visibility of order status.

An exemplary embodiment of the present invention is an interactive web-based application that tracks all NPRC-controlled orders through various legacy systems used in the provisioning process. An exemplary embodiment of the present invention allows users (NPRC and others) to track and analyze an order in real time and escalate problems to the appropriate group. This may lead to an increase in the efficiency of the NPRC. Additionally, service-order based information is collected and stored to allow proactive root cause analysis. Information about a service order may be stored and managed within the system using a relational database. Escalation mechanisms are built into the system and inform NPRC users when there is a need to escalate based on rules defined in the database. Furthermore, an exemplary embodiment of the present invention allows direct updates to legacy systems to be performed. This may lead to savings in user time and to more consistent data.

An exemplary embodiment of the present invention also does the following: provides all provisioning groups with the ability to forecast load-balancing and work effort within their areas in order to meet Intermediate Critical Dates (ICDs); customizes escalation timers in order to notify NPRC users if a CDD or ICD is at risk; collects “real time” (within about one hour) metrics to support performance analysis; presents an easily navigable web-page of CDD and all designed services critical data drawn from multiple systems presenting a single data screen to the user; provides content, context, and individual system-sensitive dynamic on-screen help procedures; allows the user to make updates to several systems from a single screen interface; and gives outside customers the ability to request appropriate information on and the current status of their service requests.

An exemplary embodiment of the present invention may replace a manual, paper-based order tracking system. By eliminating the manual effort, more time may be spent on managing the process and more orders may be managed. This may lead to a faster commitment to the customer on an order and a higher degree of CDDs being met.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An exemplary embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for strategic priority order tracking, the method comprising:
receiving a request to access an order tracking database from a user system, wherein the data contained in said order tracking database is sourced from at least one legacy database;
transmitting order status data for a customer order to said user system in response to a request from said user system to display said order status data for said customer order, wherein said order status data is responsive to data included in said order tracking database corresponding to said customer order and said order status data is displayable as a single screen on said user workstation;
creating a customized report in response to a request from said user system to create the customized report, wherein said customized report is responsive to data included in said order tracking database, a data field, a filter option and a sorting option;
transmitting said customized report to said user system in response to said creating a customized report;
updating said order status data for said customer order in response to a request from said user system, wherein said updating includes updating data in said at least one legacy database;
transmitting said order status data to a provisioning group responsible for performing labor requested on said customer order in response to said updating said order status data; and
escalating a priority level associated with said customer order in response to a request to escalate said customer order.

2. The method of claim 1 wherein said at least one legacy database includes a TIRKS database, a SOAC database, a SOCS database, a WFA database, a DPRO database and a LFACS database.

3. The method of claim 2 wherein said at least one legacy database further includes a BOSIP database.

4. The method of claim 1 wherein said at least one legacy database includes a total circuit provisioning process database, a service order receiver and assignment database, a routing of service orders database, a service order personnel assignment database and a loop facility assignment control system database.

5. The method of claim 1 wherein said order status data includes a text document created by a legacy system and stored in said legacy database.

6. The method of claim 5 wherein said legacy system is a DPRO system and said legacy database is a DPRO database.

7. The method of claim 1 wherein said order status data includes a database file created by a legacy system and stored in said legacy database.

8. The method of claim 1 wherein said request from said user system to display said order status data for said customer order includes an electronic spreadsheet including one or more of said customer orders and said transmitting order status data includes transmitting said order status data for said one or more said customer orders.

9. The method of claim 1 wherein said creating a customized report includes:
transmitting a list of optional data fields included in said order tracking data base to said user system, wherein said optional data elements include said data field;
transmitting a list of filter selections to said user system, wherein said list of filter selections includes said filter option;
transmitting a list of sorting selections to said user system, wherein said list of sorting selections includes said sorting option;
receiving said data field, said filter option and said sorting option from said user system;
automatically generating a query in response to said data field, said filter option and said sorting option; and executing said query against said order tracking database.

10. The method of claim 9 wherein said filter option includes an account executive employee number.

11. The method of claim 9 wherein said filter option includes a sales consultant employee number.

12. The method of claim 1 further comprising performing an instant messaging function in response to a request from said user system to perform said instant messaging function.

13. The method of claim 1 wherein access to said order tracking database is restricted to a subset of said order tracking database responsive to a user identification associated with the user of said user system.

14. The method of claim 1 further comprising creating a project report in response to a request from said user system to create the project report, wherein said project report includes order status data for a customer order associated with a project number received by said user system.

15. The method of claim 1 wherein said customer order includes a field to specify if said customer order refers to an unbundled network element.

16. The method of claim 1 further comprising creating a project report in response to a request from said user system to create the project report, wherein said project report includes order status data for a customer order associated with a project number received by said user system.

17. The method of claim 1 wherein said user system is accessed by a network provisioning resolution center user.

18. The method of claim 1 wherein said user system is accessed by a customer.

19. The method of claim 1 wherein escalating a priority level associated with the order comprises determining an interval of time by which the labor requested on the order must be completed.

20. The method of claim 1, wherein escalating a priority level associated with the order comprises determining whether a critical date has been reached.

21. The method of claim 1, wherein escalating a priority level associated with the order comprises:
determining whether said provisioning group is responsible for performing the labor requested on the order received the order within a specified period of time; and
in response, adjusting the priority level associated with the order according to whether the provisioning group received the order within the specified time.

22. A system for strategic priority order tracking, the system comprising:
a network;
a first storage device in communication with said network, wherein said first storage device includes an order tracking database;
a second storage device in communication with said network, wherein said second storage device includes at least one legacy database;
a user system in communication with said network; and
a host system in communication with said network, said host system including application software to implement a strategic priority order tracking method comprising:
receiving a request to access said order tracking database from said user system, wherein the data contained in said order tracking database is sourced from said at least one legacy database;
transmitting order status data for a customer order to said user system in response to a request from said user system to display said order status data for said customer order, wherein said order status data is responsive to data included in said order tracking database corresponding to said customer order and said order status data is displayable as a single screen on said user workstation;
creating a customized report in response to a request from said user system to create the customized report, wherein said customized report is responsive to data included in said order tracking database, a data field, a filter option and a sorting option;
transmitting said customized report to said user system in response to said creating a customized report;
updating said order status data for said customer order in response to a request from said user system, wherein said updating includes updating data in said at least one legacy database;
transmitting said order status data via said network to a provisioning group responsible for performing labor requested on said customer order in response to said updating said order status data; and
escalating a priority level associated with said customer order in response to a request to escalate said customer order.

23. The system of claim 22 wherein said host system comprises a first central processing unit and a second central processing unit wherein said first central processing unit reads data from said at least one legacy database and updates said order tracking database and wherein said second central processing unit updates said at least one legacy database.

24. The system of claim 22 wherein said order tracking database includes a current order tracking database and an archive order tracking database.

25. The system of claim 22 wherein said network is the Internet.

26. The system of claim 22 wherein said network is an intranet.

27. The system of claim 22 wherein said order tracking database is a relational database.

28. A computer program product for strategic priority order tracking, the computer program product comprising:
a storage medium readable by a processing circuit and storing instructions for execution by the processing circuit for performing a method comprising:
receiving a request to access an order tracking database from a user system, wherein the data contained in said order tracking database is sourced from at least one legacy database;
transmitting order status data for a customer order to said user system in response to a request from said user system to display said order status data for said customer order, wherein said order status data is responsive to data included in said order tracking database corresponding to said customer order and said order status data is displayable as a single screen on said user workstation;
creating a customized report in response to a request from said user system to create the customized report, wherein said customized report is responsive to data included in said order tracking database, a data field, a filter option and a sorting option;
transmitting said customized report to said user system in response to said creating a customized report;
updating said order status data for said customer order in response to a request from said user system, wherein said updating includes updating data in said at least one legacy database;
transmitting said order status data to a provisioning group responsible for performing labor requested on said customer order in response to said updating said order status data; and
escalating a priority level associated with said customer order in response to a request to escalate said customer order.
